(19) United States
(12) Patent Application Publication
(10) Pub. No.: US 2012/0287039 A1
(43) Pub. Date: Nov. 15, 2012

(54) USER INTERFACE FOR APPLICATION SELECTION AND ACTION CONTROL

(76) Inventors: Craig Brown, Cypress, TX (US); Sana Ali, Houston, TX (US); Eric Dudkowski, Houston, TX (US)

(21) Appl. No.: 13/575,144

(22) PCT Filed: Jan. 28, 2010
(86) PCT No.: PCT/US10/22348

§ 371 Date: Jul. 25, 2012

(51) Int. Cl. G06F 3/01

(52) U.S. Cl. 345/156

(57) ABSTRACT

Example embodiments disclosed herein relate to a computing device including a processor and a machine-readable storage medium, which may include instructions for displaying a first interface area in a user interface, the first interface area including a plurality of application selection controls, each corresponding to an application accessible to the computing device. The storage medium may further include instructions for displaying a second interface area in the user interface, the second interface area including a plurality of action controls, wherein each action control is associated with a function of the application corresponding to a currently-selected application selection control. Finally, the storage medium may include instructions for displaying a third interface area in the user interface, the third interface area comprising an interface of the application corresponding to the currently-selected application selection control. Example methods and machine-readable storage media are also disclosed.

### BACKGROUND

A typical computing device, such as a personal computer, laptop computer, or mobile phone, allows for execution of a significant number of applications, each for accomplishing a particular set of tasks. Many users frequently access a number of these applications, often at the same time. For example, a typical business user might require access to an email client, an instant messaging client, a word processor, a spreadsheet application, and an Internet browser. As another example, a mobile phone user might require access to a list of contacts, a text messaging service, a calendar, and a multimedia player.

Although typical operating systems implemented in computing devices allow a user to run multiple application instances, it is often difficult to quickly switch between applications and control features of each application. Furthermore, some applications may be contained in a menu not easily accessible to the user, such that the user is unaware of the availability of the applications.

Similarly, many computing devices provide access to the World Wide Web through a web browsing application. Although most web browsers allow a user to open multiple web pages or web-based applications simultaneously, the user is often forced to switch between tabbed pages and must interact with each page differently depending on the particular arrangement of the page. Furthermore, as with a menu containing multiple applications, a user may be unaware of the existence of a particular web page.

As should be apparent, operating systems, web browsers, and other interfaces for accessing applications require significant user interaction to switch between or launch applications. In addition, the lack of a common interface makes it disorienting when rapidly changing between applications, as the user must adjust to the new interface. Ultimately, existing interfaces for launching, changing, and controlling applications prevent efficient interaction with the user.

### BRIEF DESCRIPTION OF THE DRAWINGS

In the accompanying drawings, like numerals refer to like components or blocks. The following detailed description references the drawings, wherein:

FIG. 1 is a block diagram of an embodiment of a computing device including a machine-readable storage medium encoded with instructions for displaying a user interface;

FIG. 2 is a block diagram of an embodiment of a computing device and an example of an interaction with a user for displaying and controlling a user interface;

FIG. 3A is an example of an embodiment of a user interface for displaying application selection controls and corresponding action controls;

FIG. 3B is an example of an embodiment of a user interface for displaying application selection controls and corresponding action controls, the interface including an input control and an activation control;

FIG. 4 is an example of an embodiment of a user interface for displaying a first and second interface area in a hidden state;

FIG. 5 is an example of an embodiment of a touch user interface for displaying application selection controls and corresponding action controls;

FIG. 6 is an example of a user interface including an email application selection control and corresponding action controls;

FIG. 7 is a flowchart of an embodiment of a method for displaying a user interface to a user of a computing device; and

FIGS. 8A & 8B are flowcharts of an embodiment of a method for displaying a user interface to a user of a computing device.

### DETAILED DESCRIPTION

As described above, a typical interface for launching, changing, and controlling applications lacks user-friendliness and prevents efficient control by the user. Accordingly, as described in detail below, various example embodiments relate to a user interface that includes three interface areas, a first including controls for selecting an application, a second including action controls for the currently-selected application, and a third including the usual interface of the application. In this manner, a user may quickly select an application from the first area and then control one or more actions of the application from the second area. In addition, because the third area includes the interface of the application, the user may retain access to all controls of the application. Additional embodiments and applications will be apparent to those of skill in the art upon reading and understanding the following description.

In the description that follows, reference is made to the term, “machine-readable storage medium.” As used herein, the term “machine-readable storage medium” refers to any electronic, magnetic, optical, or other physical storage device that stores executable instructions or other data (e.g., a hard disk drive, random access memory, flash memory, etc.).

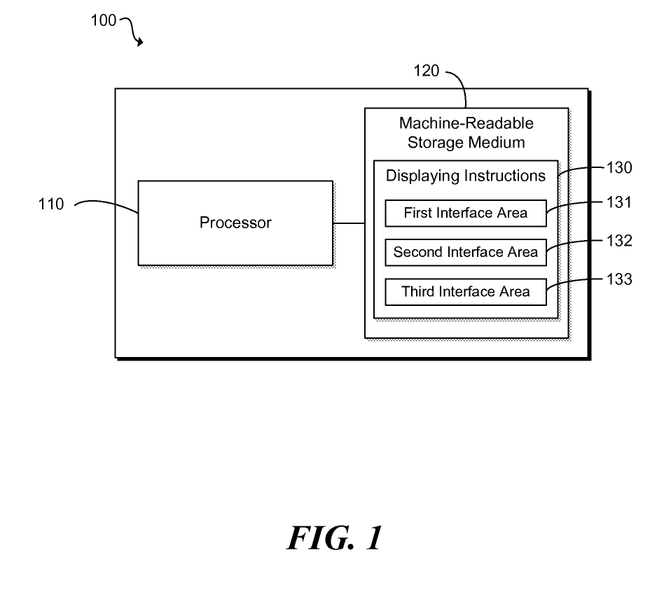

Referring now to the drawings, FIG. 1 is a block diagram of an embodiment of a computing device 100 including a machine-readable storage medium 120 encoded with instructions for displaying a user interface. Computing device 100 may be, for example, a desktop computer, a laptop computer, a handheld computing device, a mobile phone, or the like. In the embodiment of FIG. 1, computing device 100 includes processor 110 and machine-readable storage medium 120.

Processor 110 may be a central processing unit (CPU), a semiconductor-based microprocessor, or any other hardware device suitable for retrieval and execution of instructions stored in machine-readable storage medium 120. In particular, processor 110 may fetch, decode, and execute displaying instructions 130 to implement the functionality described in detail below.

Machine-readable storage medium 120 may be encoded with executable instructions for displaying a user interface that enables a user to interact with one or more applications. These executable instructions may be, for example, a portion of an operating system (OS) of computing device 100 or a separate application running on top of the OS to present a user interface. As another example, the executable instructions may be included in a web browser, such that the web browser implements the interface described in detail herein. Alternatively, the executable instructions may be implemented in web-based script interpretable by a web browser, such as JavaScript. Other suitable formats of the executable instructions will be apparent to those of skill in the art.

More specifically, machine-readable storage medium 120 may be encoded with displaying instructions 130, which may be configured to display a first interface area 131, a second interface area 132, and a third interface area 133. As described in detail below, the combination of these three interface areas simplifies launching, changing, and controlling available applications.

In some embodiments, the first interface area 131 includes a plurality of application selection controls, each corresponding to an application accessible to computing device 100. The application selection controls may be, for example, icons or text representing the application, selectable buttons, selectable items in a list, and the like. It should be apparent that the application selection controls may be any suitable interface elements that identify the application to the user and detect selection of the application by the user. User selection of a particular application selection control may be detected based on a mouse click, keyboard entry, touch entry, or any other form of input.

The applications accessible to computing device 100 may include executable software applications, such as word processors, web browsers, email clients, calendars, spreadsheet applications, media editors or players, and any other software that may be executed by computing device 100. Such applications may be stored on machine-readable storage medium 120, a remote server, or on some other storage medium that may be accessed by computing device 100. In addition, the applications accessible to computing device 100 may include web pages or web-based applications. As an example, the applications may include web-based social networking applications, web-based email, news or sports websites, blogs, and the like.

Regardless of the particular applications accessible to computing device 100, first interface area 131 may display a number of these applications and allow for user selection of a corresponding application selection control. The applications displayed in first interface area 131 may be populated in a number of ways. As one example, displaying instructions 130 may be preconfigured to display commonly-used applications. In addition, or as an alternative, a user may specify the applications to be displayed in first interface area 131. As another alternative, displaying instructions 130 may automatically update the displayed applications based on those most frequently accessed by the user.

Upon selection of a particular application selection control in first interface area 131, displaying instructions 131 may take a number of possible actions. For example, when the application is not yet running or otherwise open, displaying instructions 131 may trigger loading and execution of the application by computing device 100. Similarly, when the application is a web page or web-based application that is not yet open, displaying instructions 131 may launch a web browser, if necessary, and instruct the browser to load the appropriate location. Alternatively, when the application is currently running, but not visible, displaying instructions 131 may bring the application into focus for display in third interface area 133.

Second interface area 132 may include a plurality of action controls that vary depending on the application selection control that is currently selected in first interface area 131. In particular, upon user selection of one of the applications displayed in first interface area 131, displaying instructions 130 may update second interface area 132 to include a number of actions available for the selected application. As with the application selection controls, the action controls may be icons or text representing the action, selectable buttons, selectable items in a list, or any other interface elements that identify the action to the user and detect selection of the action by the user. Again, selection of a particular action control may be based on a mouse click, keyboard entry, touch entry, or any other form of input.

Each action control may correspond to any function of the currently-selected application. As an example, if the application selected in first interface area 131 is a web browser, the action controls displayed in second interface area 132 may include a back control, a forward control, a refresh control, a homepage control, and a search box. As another example, if the application selected in second interface area 131 is a social-networking web application, the action controls displayed in second interface area 132 may include controls for accessing photos, viewing friend updates, and posting updates. Other suitable action controls will be apparent to those of skill in the art based on the particular applications accessible by computing device 100.

As with the application selection controls, the action controls to be displayed in second interface area 132 may be determined in a number of ways. As one example, displaying instructions 130 may include a preconfigured set of commonly-used actions for each application. As an alternative or in addition, the user may customize the set of actions for each application. Alternatively, displaying instructions 130 may dynamically update the action controls for each application based on the actions most frequently accessed by the user.

In some embodiments, the actions displayed in second interface area 132 correspond to controls in the user interface of the application currently displayed in third interface area 133. In this manner, a user may activate a particular functionality of the application using either second interface area 132 or third interface area 133. Furthermore, in some embodiments, displaying instructions 130 may dynamically update the actions displayed in second interface area 132 based on the actions currently displayed in third interface area 133. In such embodiments, the actions displayed in second interface area 132 will correspond only to those that are available in the currently-displayed interface of the application.

Third interface area 133 may display the user interface of the currently-selected application. In particular, third interface area 133 may include the typical user interface that would be displayed without the presence of first interface area 131 and second interface area 132. For example, when the currently-selected application is a word processor, third interface area 133 may include a text-editing area, formatting toolbars, and a set of drop-down menus for accessing other functions. As another example, when the currently-selected application is a website containing news, third interface area 133 may include the web browser actions, current headlines, and other content of the website.

Third interface area 133 may be displayed in a number of positions with respect to first interface area 131 and second interface area 132. As one example, third interface area 133 may be resized, such that first interface 131 and second interface area 132 do not obscure any portion of the application's interface. As another example, first interface area 131 and second interface area 132 may overlap third interface area 133, and may be either opaque or transparent. Other suitable arrangements of the interface areas will be apparent to those of skill in the art.

In some embodiments, the actions available in second interface area 132 may duplicate a subset of the actions available in the user interface displayed in third interface area 133. Such embodiments are advantageous, as a user may quickly access commonly-used actions from second interface area 132, while retaining access to the full interface in third interface area 133. In addition, while gaining familiarity with the shortcuts contained in second interface area 132, the user may continue to access the commonly-used actions in third interface area 133.

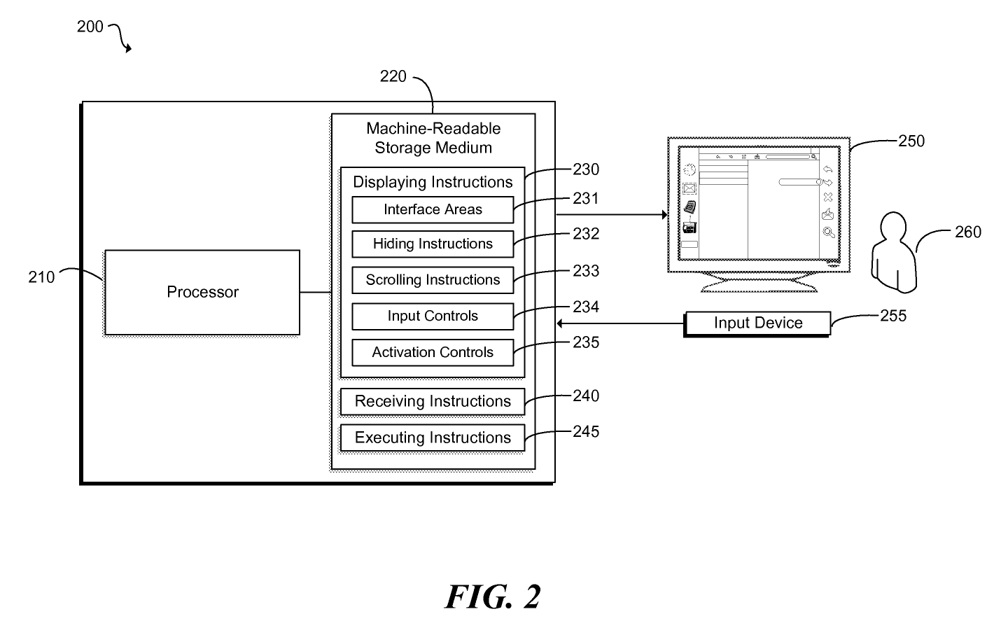

FIG. 2 is a block diagram of an embodiment of a computing device 200 and an example of an interaction with a user 260 for displaying and controlling a user interface. As illustrated, computing device 200 may include processor 210, machine-readable storage medium 220, displaying instructions 230, receiving instructions 240, and executing instructions 245.

As with processor 110, processor 210 of FIG. 2 may be a central processing unit (CPU), a semiconductor-based microprocessor, or any other hardware device suitable for retrieval and execution of instructions stored in machine-readable storage medium 220. In particular, processor 210 may fetch, decode, and execute instructions 230, 240, 245 to implement the functionality described in detail below.

Machine-readable storage medium 220 may be encoded with executable instructions for displaying a user interface that enable a user to interact with one or more applications. As with instructions 130, the executable instructions encoded on machine-readable storage medium 220 may be a portion of an OS, a standalone application, a portion of a web browser, web-based script, and other similar formats. Displaying instructions 230 may be configured to display first, second, and third interface areas 231 for control of the application, as described in detail above in connection with displaying instructions 130 of FIG. 1.

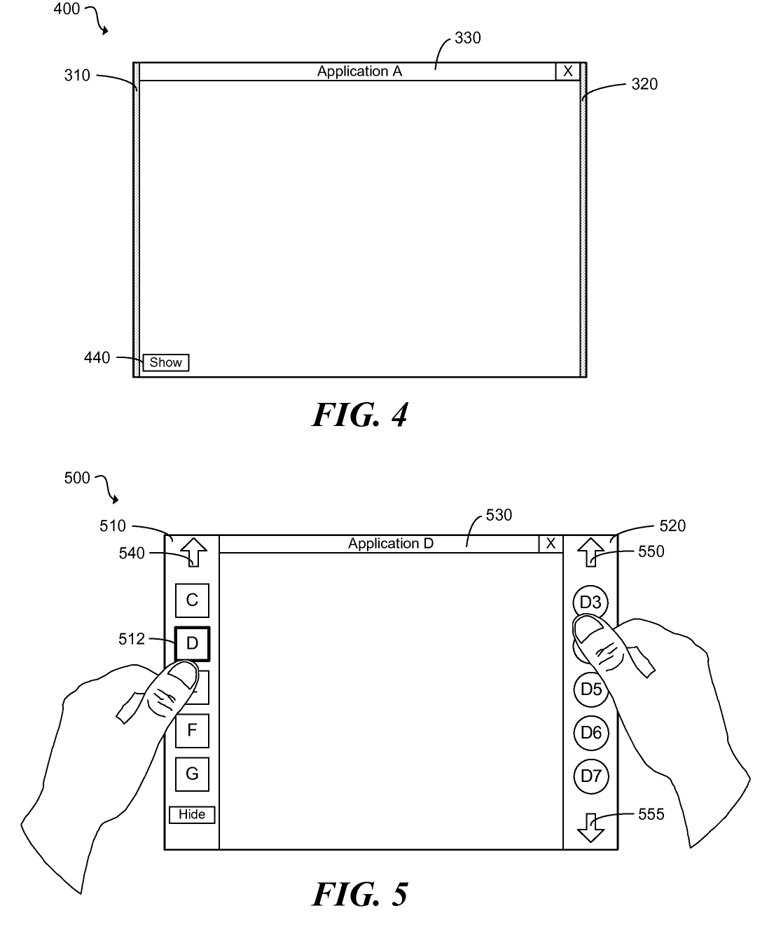

In addition, displaying instructions 230 may include hiding instructions 232, which may hide the first and second interface areas from view in some circumstances. In some embodiments, hiding instructions 232 may default to a hidden state of the first and second interface areas, such that these areas are not fully visible until receipt of an indication to display them. For example, the first and second interface areas may remain hidden until the user selects a predetermined key, selects a display control in the user interface (e.g., a “Show” button), or makes a particular mouse or touch gesture. An example implementation of a hidden configuration of the first and second interface areas is described in further detail below in connection with FIG. 4.

Furthermore, in embodiments in which hiding instructions 232 default to a hidden configuration, the first and second interface areas may return to a hidden state upon expiration of a predetermined time period without user interaction with the interface areas. For example, the first and second interface areas may return to a hidden state when a user has not touched, clicked, or otherwise interacted with the interface areas for five seconds, ten seconds, or any other time period. In addition or as an alternative, a user may manually issue a “hide” command by, for example, pressing an appropriate key or button or gesturing in a predetermined manner.

In some embodiments, transition animations may be included between the visible and hidden states of the first and second interface areas. As one example, upon receipt of an indication to display the first and second interface areas, the areas may gradually slide into view from a side of the screen. The interface areas may then gradually slide out of view when returning to the hidden state. As another example, the transparency of the interface areas may gradually increase to 100% to enter a hidden state and gradually decrease to enter a visible state. Alternatively, the interface areas may toggle between hidden and visible states without the use of transitions.

It should be noted that, in some embodiments, the first and second interface areas may be displayed and hidden independently of one another. For example, the first interface area may be displayed upon receipt of an indication to display application selection controls, while the second interface area may be displayed upon receipt of a different indication to display the action controls. Similarly, hiding of the interface areas may be accomplished in response to expiration of different timers or in response to receipt of different indications to hide the interface areas.

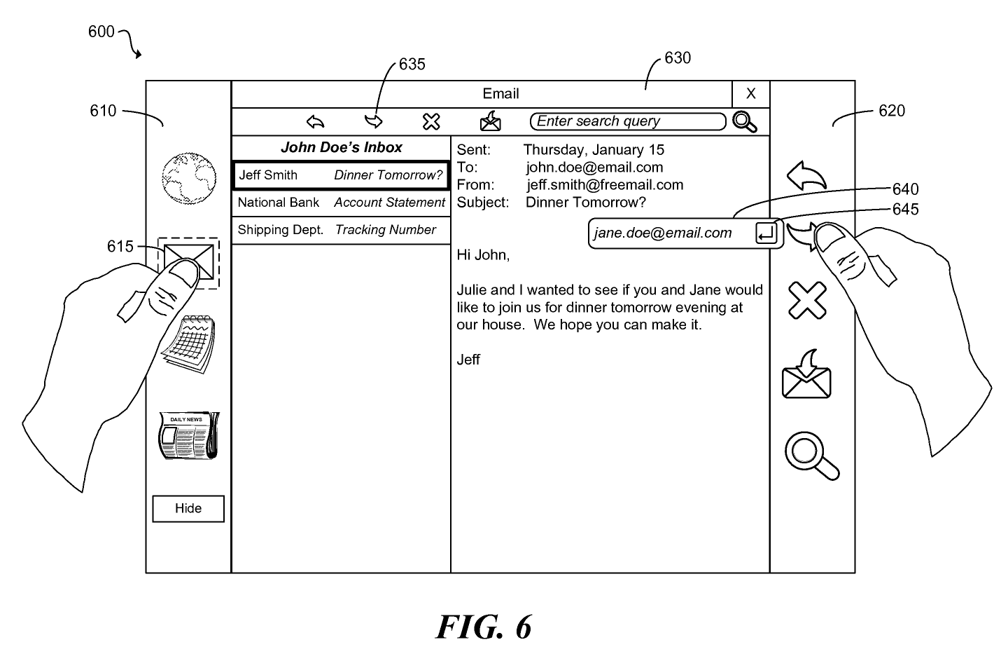

Displaying instructions 230 may also include scrolling instructions 233 to allow a user to view a new range of application selection controls in the first interface area and a new range of action controls in the second interface area. In particular, when a number of applications available in the first interface area or a number of actions available in the second interface area exceeds a number that may be displayed simultaneously, scrolling instructions 233 may allow the user to move non-displayed controls into view. An example implementation of scrolling capability is described in further detail below in connection with FIG. 5.

As one example, scrolling instructions 233 may be implemented as a scroll bar interface element. In some embodiments, scrolling instructions 233 may include an arrow or other selectable control on each end of a bar, with an additional element indicating the user's position within the scroll bar. By selecting a particular arrow or other control, a user may change the visible portion of the particular interface area, thereby displaying previously-obscured applications or actions.

In touch implementations, a user may also scroll through the available controls by touching a portion of the first or second interface area and making a flicking motion in an appropriate direction. Scrolling instructions 233 may then determine a speed and/or inertia of the gesture and scroll to a determined location in the particular interface. Other suitable implementations for scrolling instructions 233 will be apparent to those of skill in the art.

Displaying instructions 230 may be further configured to display input controls 234 upon selection of one or more corresponding application selection or action controls. In particular, input controls 234 may receive input from a user for controlling a function of the application or for specifying a parameter for a particular action control. In this manner, the user may interact with or control the application from the first or second interface areas without the need for controlling the application from the third interface area. In some embodiments, the input controls 234 may be displayed adjacent to the selected control, such that the user's attention will automatically focus on the displayed input control.

Input controls 234 used in conjunction with an application selection control may be used for setting preferences of an application, selecting a launch parameter, or otherwise communicating data to the particular application. As one example, if the selected application is a web browser, an input control 234 may be displayed to request input of a Uniform Resource Locator (URL) to be accessed upon activation of the browser. As another example, if the selected application is a web-based email service, the input control 234 may request entry of a user name or password. Other suitable uses of input controls 234 in connection with applications will be apparent to those of skill in the art.

Similarly, input controls 234 used in conjunction with action controls may be used to specify parameters for an application function or otherwise provide information used in executing the particular function. For example, if the selected application is a word processor and the selected action is a font selection, the input control 234 may request user entry or selection of the desired font. As another example, if the selected application is a social networking application and the selected action is “Post status,” the input control 234 may request user entry of the text to be posted. Other suitable uses of input controls 234 in connection with action controls will be apparent to those of skill in the art.

In conjunction with input controls 234, displaying instructions 230 may be further configured to display an activation control 235. In particular, an activation control 235 may be a button or similar interface element that receives an indication from the user that he or she has completed interaction with the corresponding input control 234. Activation control 235 may be displayed in any position near the corresponding input control, provided that the user understands that activation control 235 is associated with input control 234. Selection of activation control 235 by the user may then trigger execution of the particular application or function using the parameter or other information entered using input control 234.

For example, if the input control 234 is for a URL to be launched by a web browser, activation control 235 may be labeled, “Launch,” and, when selected, trigger execution of the web browser using the entered URL. As another example, if the input control is for entry or selection of a font by the user in a word processor, user selection of activation control 235 may trigger the word processor to apply the appropriate font change to any selected text. Other suitable activation controls 235 for particular applications or actions will be apparent to those of skill in the art.

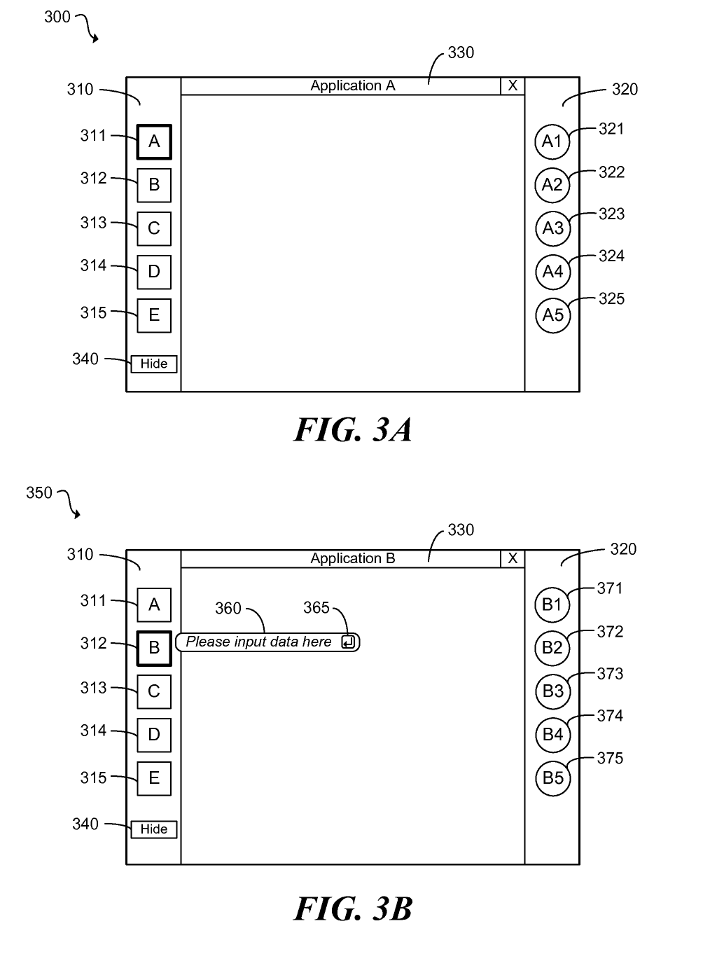

Machine-readable storage medium 220 may also include receiving instructions 240, which may be configured to receive and process instructions provided by user 260 through input device 255. In particular, receiving instructions 240 may be configured to detect and process input from the user to hide, display, or scroll the first and second interface areas, launch or switch to a new application, execute a particular action, and interact with the input and activation controls. User input may be provided through a user interface, such as the example interfaces described in detail below in connection with FIGS. 3-6. Receiving instructions 240 may be configured to receive and process inputs from a variety of input devices, as described in detail below in connection with input device 255.

Finally, machine-readable storage medium 220 may include executing instructions 245, which may be configured to interact with the applications managed by the interface. In particular, executing instructions 245 may be configured to launch or switch to an application upon selection of an application control by the user. In addition, executing instructions 245 may be configured to execute a particular action upon selection of an action control by the user.

In some embodiments, executing instructions 245 may interact with the applications through the use of an Application Programming Interface (API). In particular, an API of an application, whether locally-executed or web-based, may expose a number of functions to other applications. Similarly, an API of an operating system may expose a number of functions used to control the functionality of the OS. Executing instructions 245 may therefore be configured to access a particular API function for each application selection or action control.

For example, when the user interface is implemented as an application on top of the OS, launching and switch applications in response to user selection of an application control may be implemented using an API of the OS. As another example, when the selected application is a web-based social networking site, each action control may be implemented using a particular function provided in an API for the site. Thus, upon user selection of a particular action control, executing instructions 245 may call an appropriate API function using any parameters provided by the user. Interaction with other applications may be implemented in a similar manner.

Output device 250 may include a display device, such as a cathode ray tube (CRT) monitor, a liquid crystal display (LCD) screen, or a screen implemented using another display technology. It should be apparent, however, that any suitable display may be used, provided that the first, second, and third interface areas are displayed to user 260. Output device 250 may be internal or external to computing device 200 depending on the configuration of computing device 200.

Input device 255 may include a mouse, a keyboard, a touchpad, and/or a microphone. It should be apparent, however, that any suitable input device may be used, provided that user 260 may communicate instructions to computing device 200. Input device 255 may be internal or external to computing device 100 depending on the configuration of computing device 100.

FIG. 3A is an example of an embodiment of a user interface 300 for displaying application selection controls and corresponding action controls. As illustrated, user interface 300 includes first interface area 310, second interface area 320, and third interface area 330.

In this embodiment, first interface area 310 and second interface area 320 are illustrated on opposite sides of the user interface, while third interface area 330 is between the two. In particular, first interface area 310 is located on the left side of interface 300, while second interface area 320 is located on the right side of interface 300. Such an arrangement is particularly advantageous in touch screen implementations, as the user may select applications using his or her left hand, while controlling the actions of the applications using his or her right hand. This enables a user to quickly switch between and control multiple applications.

It should be apparent that other arrangements and orientations may be used for interface 300. For example, the locations of the interface areas could be swapped, such that first interface area 310 is on the right side of interface 300, while second interface area 320 is on the left side. As another example, first interface area 310 could be located on the top or bottom of the screen, while second interface area 320 could be located on an opposite side. Furthermore, first interface area 310 and second interface area 320 could be located on the same side of the screen. In addition, first interface area 310 and second interface area 320 need not extend across an entire side of interface 300. Other suitable arrangements and orientations of the interface areas will be apparent to those of skill in the art.

In the example illustrated in FIG. 3A, first interface area 310 includes application selection controls for a number of different applications. In this example, first interface area 310 provides access to Application A 311, Application B 312, Application C 313, Application D 314, and Application E 315.

As illustrated, the user has selected Application A 311. Thus, second interface area 320 includes a number of action controls, each corresponding to a function of Application A 311. Thus, action controls A1 321, A2 322, A3 323, A4 324, and A5 325 each correspond to a different function of Application A 311. Furthermore, third interface area 330 may include the interface of Application A 311.

In addition, first interface area 310 may include a hide control 340, which, upon activation by the user, may hide first interface area 310 and second interface area 320, leaving only third interface area 330 visible. It should be noted that, although a single hide control 340 is illustrated, second interface area 320 may include another hide control, such that first interface area 310 and second interface area 320 may be hidden independently from one another.

FIG. 3B is an example of an embodiment of a user interface 350 for displaying application selection controls and corresponding action controls, the interface including an input control 360 and an activation control 365. As illustrated in FIG. 3B, the user has selected Application B 312, which has triggered display of input control 360 and activation control 365. Using input control 360, the user may enter a parameter used in launching to Application B 312. Upon entering the necessary information into input control 360, the user may then select activation control 365 to launch Application B 312 using the parameter contained in input control 360.

In addition, as a result of the user's selection of Application B 312, second interface area 320 is now updated to show action controls B1 371, B2 372, B3 373, B4 374, and B5 375, each corresponding to a particular function of Application B 312. Furthermore, third interface area 330 is now updated to show the interface of Application B 312.

FIG. 4 is an example of an embodiment of a user interface 400 for displaying first and second interface areas 310, 320 in a hidden state. In particular, as illustrated, first interface area 310 and second interface area 320 have shifted towards the edge of the screen, such that only a portion of the interface areas 310, 320 is visible. In this configuration, user interface 400 uses the large majority of the available display area for third interface area 330, which displays the interface of Application A.

When first and second interface areas 310, 320 are in the hidden state, interface 400 may include a show control 440, which may be activated to return first interface area 310 and second interface area 320 to the visible state. In particular, upon selection of show control 440, first interface area 310 and 320 may, for example, slide into view in a configuration similar to that of FIG. 3A. Alternatively, the visible state may be activated using a touch gesture, a mouse gesture, selection of a predetermined key, or any other suitable input from the user.

It should be noted that, although illustrated as including visible bars for first interface area 310 and second interface area 320, the interface areas 310, 320 may be entirely hidden from view in some embodiments. Furthermore, as described in detail above in connection with hiding instructions 232, transition animations may be included between the visible and hidden states of first interface area 310 and second interface area 320. In addition, as also described in detail above, the first and second interface areas 310, 320 may be displayed and hidden independently of one another.

FIG. 5 is an example of an embodiment of a touch user interface 500 for displaying application selection controls and corresponding action controls. As illustrated, interface 500 includes first interface area 510, second interface area 520, and third interface area 530.

In this example, first interface area 310 includes application selection controls for a number of applications including a selected application, Application D 512. As illustrated by the presence of scroll indicator 540, additional applications are available for selection by the user by scrolling in an upward direction.

Second interface area 310 includes action controls D3 to D7, each corresponding to a function of the currently-selected application, Application D 512. As illustrated by the presence of scroll indicator 550, additional actions prior to D3 are available for selection by the user by scrolling in an upward direction. Furthermore, as indicated by scroll indicator 555 additional actions subsequent to D7 are available for selection by the user by scrolling in a downward direction.

As illustrated, the user may control the scrolling functionality using his or her thumbs or fingers. As one example, the user may scroll to the top by flicking the appropriate interface area 510, 520 in a downward direction. Similarly, the user may scroll to the bottom by flicking the appropriate interface area 510, 520 in an upward direction. Alternatively, the user may scroll in the upward direction in first interface area 510 by touching or clicking scroll indicator 540. Similarly, the user may scroll in the upward or downward direction in second interface area 520 by touching or clicking scroll indicators 550 and 555, respectively. It should noted, however, that non-touch implementations for scrolling may be used, such as those described above in connection with scrolling instructions 233 of FIG. 2.

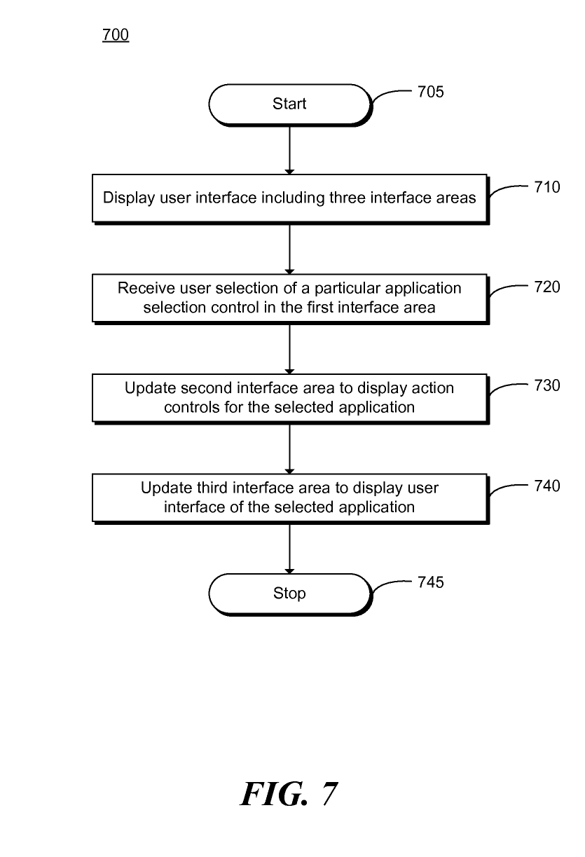

FIG. 6 is an example of a user interface 600 including an email application selection control 615 and corresponding action controls 630. As illustrated in the example interface 600, first interface area 610 includes a plurality of icons, each corresponding to a particular application. Thus, a user may quickly launch or switch between a web browser, an email application 615, a calendar, and a news source.

In this example, the user has selected email application 615. Accordingly, second interface area 620 includes a plurality of application controls corresponding to functions of the email application 615. Furthermore, third interface area 630 includes the typical interface of the email application.

Here, the user has selected a forward control in second interface area 620, which corresponds to forward control 635 in the interface of the email application. In response to the user's selection of the forward action control in second interface area 620, interface 600 displays an input control 640 and an activation control 645. In particular, input control 640 allows for user entry of an email address to which the current message should be forwarded, while selection of activation control 645 executes the forwarding function of email application 615.

Thus, as illustrated, a user may efficiently select an application and perform an appropriate action by interacting with only first interface area 610 and second interface area 620. Inclusion of third interface area 630 provides flexibility and familiarity to the user. For example, if the user is more familiar with the typical interface of email application 615, he or she may perform the same actions using third interface area 630.

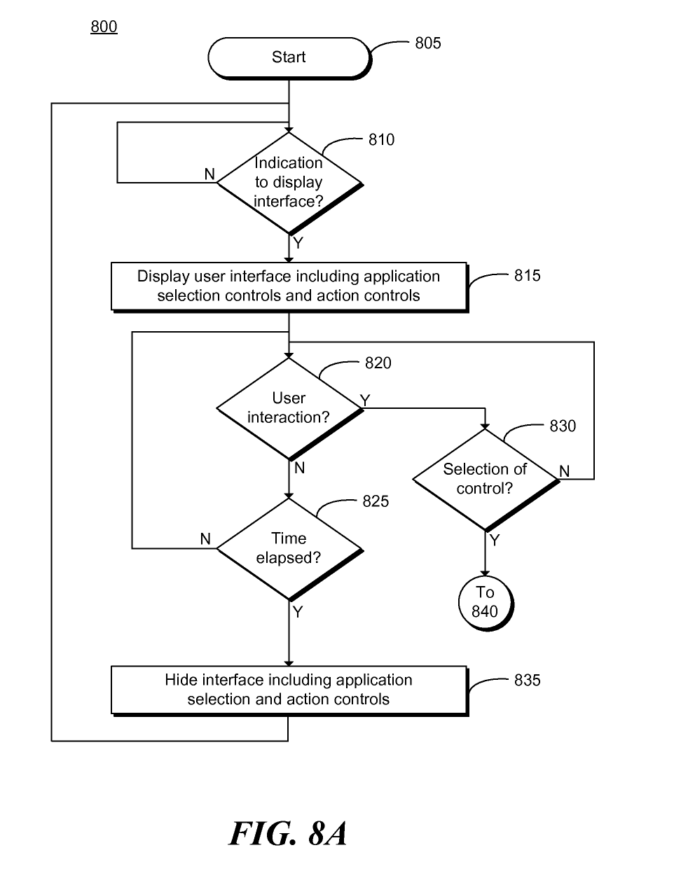

FIG. 7 is a flowchart of an embodiment of a method 700 for displaying a user interface to a user of a computing device. Although execution of method 700 is described below with reference to the components of computing device 100, other suitable components for execution of method 700 will be apparent to those of skill in the art. Method 700 may be implemented in the form of executable instructions stored on a machine-readable storage medium, such as machine-readable storage medium 120 of FIG. 1.

Method 700 may start in block 705 and proceed to block 710, where computing device 100 may display a user interface including three interface areas. In particular, a first interface area may include a plurality of application selection controls, each corresponding to a particular application. A second interface area may include a plurality of action controls corresponding to functions of a currently-selected application or, in the event that no application is selected, include no controls. Finally, a third interface area may include an interface of the selected application.

After display of the interface areas, method 700 may proceed to block 720, where computing device 100 may receive user selection of a particular application selection control in the first interface area. In particular, a user may click, touch, or otherwise select an application selection control in the first interface area, indicating that he or she wishes to use the corresponding application.

Method 700 may then proceed to block 730, where computing device may update the second interface area to display action controls corresponding to the selected application. Next, method 700 may proceed to block 740, where computing device 100 may update the third interface area to display the user interface of the selected application. If the selected application is not yet loaded in memory, computing device 100 may load and launch the application in the third interface area. Alternatively, if the selected application is currently running, computing device 100 may set the selected application as the active application to be displayed in the third interface area. Method 700 may then proceed to block 745, where method 700 stops.

Although described above as comprising separate blocks, it should be apparent that the display of the particular interface areas need not occur in sequential order. Rather, in some embodiments, the interface areas may be processed for display concurrently, such that some portions of a particular interface area are outputted to a display device prior to portions of another interface area.

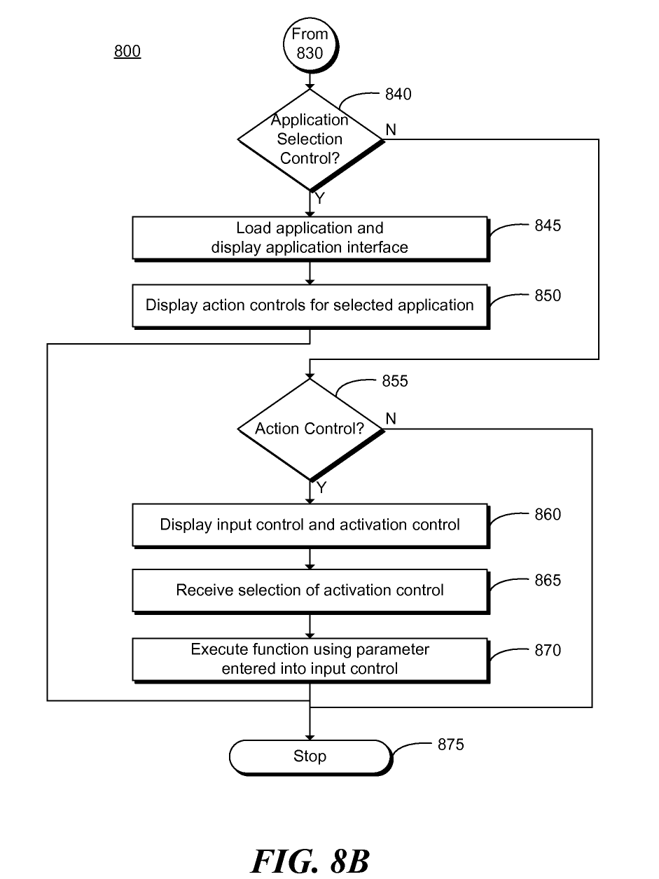

FIGS. 8A & 8B are flowcharts of an embodiment of a method 800 for displaying a user interface to a user of a computing device 200. Although execution of method 800 is described below with reference to the components of computing device 200, other suitable components for execution of method 800 will be apparent to those of skill in the art. Method 800 may be implemented in the form of executable instructions stored on a machine-readable storage medium, such as machine-readable storage medium 220 of FIG. 2.

Referring now to FIG. 8A, method 800 may start in block 805 and proceed to block 810, where computing device 200 may continuously monitor for an indication from the user to display the first and second interface areas. Such an indication may be selection of a predetermined key, selection of a control in the interface, a touch or mouse gesture, or any other input provided by a user.

After receipt of such an indication, method 800 may proceed to block 815, where computing device 200 may display first and second interface areas. In particular, a first interface area may include a number of application selection controls, each corresponding to an application accessible to computing device 200. In addition, the second interface area may include a number of action controls corresponding to functions of the currently-selected application. In some embodiments, these interface areas may be displayed concurrently with the interface of the currently-displayed application.

Method 800 may then proceed to block 820, where computing device 200 may determine whether the user has interacted with either of the first or second interface areas. Such interaction may include, for example, movement of the mouse within the interface areas, touching of the interface areas on a touch display, selection of a control, etc.

When user interaction is detected, method 800 may proceed to block 830, where computing device 200 may determine whether the interaction was a selection of an application selection control or an action control. When the user has selected an application selection control or an action control, method 800 may proceed to block 840, described in further detail below in connection with FIG. 8B. Alternatively, when the user has not selected a control, method 800 may reset a timer and return to block 820, where computing device 200 will continue to monitor for user interaction.

In block 820, when computing device 200 determines that the user has not interacted with either the first interface area or the second interface area, method 800 may proceed to block 825. In block 825, computing device 200 may determine whether the time elapsed since a last user interaction has exceeded a predetermined value (e.g., 5 seconds, 10 seconds, etc.). When such a time period has not yet elapsed, method 800 may return to block 820.

Alternatively, when the predetermined time period has elapsed since the last user interaction with the first or second interface areas, method 800 may proceed to block 835. In block 835, computing device 200 may hide the first and second interface areas from view, such that the application selection and action controls are no longer visible. Method 800 may then return to block 810 and await the next indication to display the interface.

Referring now to FIG. 8B, in block 840, computing device 200 may determine whether the selected control is an application selection control. When it is determined that the user has selected an application selection control, method 800 may proceed to block 845, where computing device 200 may display the interface for the currently-selected application in the third interface area. If the selected application is not yet loaded in memory, block 845 may include loading and launching of the application. Method 800 may then proceed to block 850, where computing device 200 may display the action controls for the currently-selected application in the second interface area. Method 800 may then proceed to block 875, where method 800 may stop until detection of further user interaction.

Alternatively, when, in block 840, it is determined that the selected control is not an application selection control, method 800 may proceed to block 855, where computing device 200 may determine whether the selected control is an action control. When it is determined that the user has selected an action control, method 800 may proceed to block 860, where computing device 200 may display an input control corresponding to the selected action. In particular, the input control may be used for receipt of a parameter used to control the function corresponding to the selected action control. Computing device 200 may also display an activation control proximate to the input control to allow a user to trigger execution of the action using the parameter entered into the input control.

Method 800 may then proceed to block 865, where computing device 200 may receive an indication that the user has selected the activation control. In response, method 800 may proceed to block 870, where computing device 200 may trigger execution of the function corresponding to the action control using the parameter entered into the input control. As described above, execution of the function may be accomplished using an API function provided by the application. Finally, method 800 may proceed to block 875, where method 800 may stop until detection of further user interaction.

According to the embodiments described in detail above, a user interface may include a first area with application selection controls to allow a user to quickly switch between applications available on a computing device. In addition, the user interface may include a second area with action controls corresponding to a currently-selected action, such that a user may control each selected application using easily-accessible controls. Finally, the user interface may include a third area containing the interface of the selected application. Thus, embodiments disclosed herein provide an efficient, user-friendly interface for launching, changing, and controlling applications, while retaining functionality of the existing application interfaces.

We claim:

1. A computing device comprising:
a processor; and
a machine-readable storage medium encoded with instructions executable by the processor for displaying a user interface, the machine-readable medium comprising:
instructions for displaying a first interface area in the user interface, the first interface area including a plurality of application selection controls, each application selection control corresponding to an application accessible to the computing device,
instructions for displaying a second interface area in the user interface, the second interface area including a plurality of action controls, wherein each action control is associated with a function of the application corresponding to a currently-selected application selection control, and
instructions for displaying a third interface area in the user interface, the third interface area comprising an interface of the application corresponding to the currently-selected application selection control.

2. The computing device of claim 1, wherein the machine-readable medium further comprises:
instructions for receiving an indication to display at least one of the first interface area and the second interface area, wherein the first and second interface areas are hidden from view until receipt of the indication.

3. The computing device of claim 2, wherein the indication is at least one of a selection of a predetermined key, a selection of a control displayed in the user interface, a touch gesture, and a mouse gesture.

4. The computing device of claim 2, wherein the machine-readable medium further comprises:
instructions for hiding the first and second interface areas from view upon expiration of a predetermined time period without user interaction with at least one of the first and second interface areas.

5. The computing device of claim 1, wherein the machine-readable medium further comprises:
instructions for scrolling within the first interface area to display a new range of application selection controls, and
instructions for scrolling within the second interface area to display a new range of action controls.

6. A machine-readable storage medium encoded with instructions executable by a processor of a computing device, the machine-readable medium comprising:
instructions for displaying a user interface, the user interface comprising:
a first interface area including a plurality of application selection controls, each application selection control corresponding to an application accessible to the computing device,
a second interface area for display of a plurality of action controls, and
a third interface area for display of an application user interface;
instructions for receiving a selection of a selected control of the plurality of application selection controls;
instructions for updating the second interface area to display a plurality of action controls for the application corresponding to the selected control; and
instructions for updating the third interface area to display a user interface of the application corresponding to the selected control.

7. The machine-readable storage medium of claim 6, wherein the machine-readable medium further comprises:
instructions for displaying an input control proximate to the selected control, the input control receiving input from a user for controlling a function of the application corresponding to the selected control.

8. The machine-readable storage medium of claim 6, wherein each of the plurality of action controls displayed in the second interface area corresponds to a control in the user interface of the application displayed in the third interface area.

9. The machine-readable storage medium of claim 6, wherein the machine-readable medium further comprises:
instructions for receiving a selection of a selected action control of the plurality of action controls;
instructions for displaying an input control in response to the selection of the action control, the input control receiving a parameter used for controlling a function of the application corresponding to the selected action control.

10. The machine-readable storage medium of claim 9, wherein the machine-readable medium further comprises:
instructions for displaying an activation control proximate to the input control, wherein selection of the activation control triggers execution of the function using the parameter entered into the input control.

11. A method for displaying a user interface to a user of a computing device, the method comprising:
displaying, by the computing device, a plurality of application selection controls in a first area of the user interface, each application selection control corresponding to a respective application;
receiving, from the user, a selection of a respective application selection control corresponding to a selected application;
displaying a plurality of action controls in a second area of the user interface, each action control corresponding to a function of the selected application; and
displaying an interface of the selected application in a third area of the user interface concurrently with the plurality of action controls.

12. The method of claim 11, wherein:
the first area is on a first side of the user interface,
the second area is on a second side of the user interface opposite the first side, and
the third area is between the first area and the second area.

13. The method of claim 12, wherein the first area is on a left side of the user interface and the second area is on a right side of the user interface.

14. The method of claim 11, further comprising:
receiving, from the user, a selection of a respective action control corresponding to a selected function; and
triggering execution of the selected function using an Application Programming Interface (API) of the selected application.

15. The method of claim 11, wherein the step of displaying selects the plurality of action controls for display in the second area based on functions currently available in the interface of the selected application.
